(19) United States
(12) Patent Application Publication
(10) Pub. No.: US 2015/0133197 A1
(43) Pub. Date: May 14, 2015

(54) METHOD AND APPARATUS FOR PROCESSING AN INPUT OF ELECTRONIC DEVICE

(71) Applicant: Samsung Electronics Co., Ltd., Suwon-si (KR)

(72) Inventors: Sungmin KWAK, Suwon-si (KR); Sooji HWANG, Suwon-si (KR)

(21) Appl. No.: 14/531,237

(22) Filed: Nov. 3, 2014

(30) Foreign Application Priority Data
Nov. 8, 2013 (KR) 10-2013-0135128

(51) Int. Cl. G10L 15/26; H04M 1/725

(52) U.S. Cl. CPC G10L 15/26; H04M 1/72519; H04M 2250/74
USPC 455/563

(57) ABSTRACT

A method and an apparatus for processing an input in the electronic device are provided. The method includes displaying an input mode screen including an input area and a display area, determining whether at least one input between a touch input and a voice input through the input area is detected, and processing the touch input and the voice input as a result of the determination so as to display the touch input and the voice input.

### CROSS-REFERENCE TO RELATED APPLICATION(S)

This application claims the benefit under 35 U.S.C. §119(a) of a Korean patent application filed on Nov. 8, 2013 in the Korean Intellectual Property Office and assigned Serial number 10-2013-0135128, the entire disclosure of which is hereby incorporated by reference.

### TECHNICAL FIELD

The present disclosure relates to an electronic device. More particularly, the present disclosure relates to a method and an apparatus for processing an input in the electronic device.

### BACKGROUND

Voice recognition refers to a voice-processing technology in which a computer interprets voice information spoken by a human and then converts the interpreted contents into character information (data). Voice recognition is one interface among interfaces which have recently received attention as a scheme of inputting a character with a language instead of a keyboard.

According to a technical development of voice recognition in a smart phone, a related application technique has been variously applied thereto. Such application techniques include an artificial intelligence-type voice recognition service recognizing a user voice command and providing an answer by searching on the Web or an on-line service, or a service which can perform phone calling, a text message sending, mail writing, a memo, a schedule reservation, an alarm, a map search, or the like with a voice.

The voice recognition service starts from a Speech To Text (STT) function switching a voice into a text. For example, an electronic document such as a text message, an e-mail, or the like may be written using the STT function in an electronic device so that a user can easily input a text.

The above information is presented as background information only to assist with an understanding of the present disclosure. No determination has been made, and no assertion is made, as to whether any of the above might be applicable as prior art with regard to the present disclosure.

### SUMMARY

According to a voice recognition service of the related art, a distinction between a punctuation mark input and a character information input is imprecise when a voice input is performed or a distinction between a command performance and a character information input is imprecise in a voice input mode.

Aspects of the present disclosure are to address at least the above-mentioned problems and/or disadvantages and to provide at least the advantages described below. Accordingly, an aspect of the present disclosure is to provide a method and an apparatus for processing an input in the electronic device.

In accordance with an aspect of the present disclosure, an input processing method of an electronic device is provided. The input processing method includes displaying an input mode screen including an input area and a display area, determining whether at least one input between a touch input and a voice input through the input area is detected, and processing the touch input and the voice input as a result of the determination so as to display the touch input and the voice input.

In accordance with another aspect of the present disclosure, an electronic device is provided. The electronic device includes a display unit configured to display character information and symbol information, an input unit configured to receive a user input, a microphone configured to receive a voice input, and a controller configured to control to display an input mode screen including an input area and a display area, to determine whether at least one input between a touch input and a voice input through the input area is detected, and to process the touch input and the voice input as a result of the determination so as to display the touch input and the voice input.

In accordance with another aspect of the present disclosure, an input mode switching method of an electronic device is provided. The input mode switching method includes entering an input mode, determining whether a motion input for an input mode switching is detected, and when the motion input has been detected, switching an input mode into at least one input mode among a sentence input mode, a punctuation mark input mode, a command input mode, and an icon input mode, and determining whether a user input or a voice input is detected, and when the user input or the voice input has been detected, switching the input mode into the detected input according to the present identified input mode so as to display the switched input mode.

In accordance with another aspect of the present disclosure, an electronic device is provided. The electronic device includes a display unit that displays character information or symbol information, an input unit configured to receive an input of a user input, a microphone configured to receive a voice input, a sensor configured to detect a motion, and a controller configured to control to determine whether a motion input for an input mode switching is detected and when the motion input has been detected, to switch an input mode into at least one input mode among a sentence input mode, a punctuation mark input mode, a command input mode, and an icon input mode, to determine whether a user input or a voice input is detected, and, when the user input or the voice input has been detected, to switch the detected input according to the identified input mode so as to display the switched input mode.

According to the present disclosure, all pieces of voice information and input information are recognized in the input mode so that the recognized voice information and input information can be switched into a character or a symbol and then be output. Further, according to the present disclosure, the input mode can be easily switched additionally using an input such as a motion other than the voice input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a problem of a technology according to the related art;

FIG. 2 is a block diagram illustrating an internal structure of an electronic device according to an embodiment of the present disclosure;

FIGS. 3, 4, and 5 illustrate an input processing method in a Speech To Text (STT) input mode according to an embodiment of the present disclosure;

FIG. 6 is a flowchart illustrating an operation order of an electronic device according to an embodiment of the present disclosure;

FIGS. 7 and 8 illustrate an input mode switching method according to an embodiment of the present disclosure; and

FIG. 9 is a flowchart illustrating an input mode switching process according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

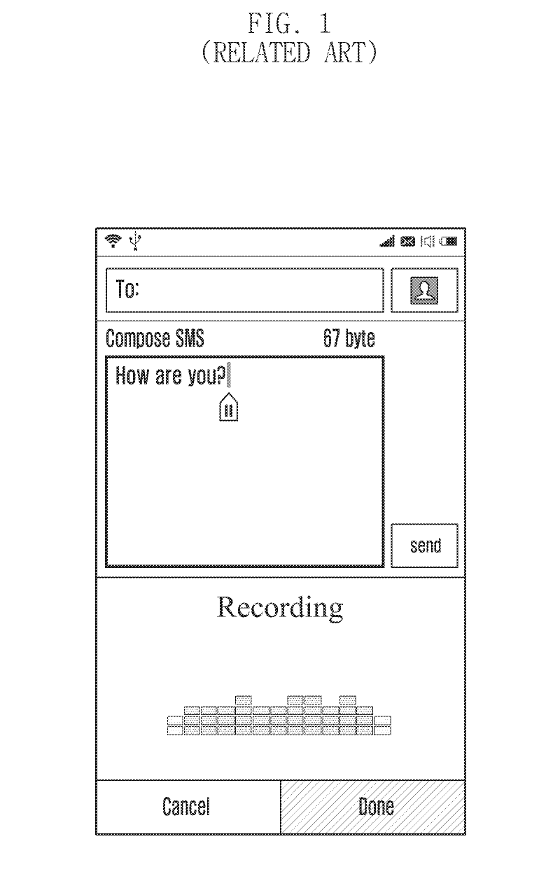

FIG. 1 illustrates a problem of a technology according to the related art.

FIG. 1 illustrates an example of writing “How are you?” in one sentence using a voice recognition service (e.g., Speech To Text (STT), or the like) in an input mode of an electronic device. In this event, the input mode may be a function provided in an application embedded in the electronic device or may be a function provided in an application which a user directly downloads from an application server, or the like. For example, the user may desire to input a specific character, a mark, or the like in an input mode of a short message service, a multimedia message service, or the like.

In order to write a sentence as illustrated in FIG. 1 through voice, according to a voice recognition service of the related art, “How are you?” is spoken in English and then “question mark” should be spoken with correct pronunciation to input a question mark (?). Other than an example as described above, in order to input an exclamation mark (!), a period (.), and a comma (,), “exclamation mark”, “period”, and “comma” should be spoken with correct pronunciation.

As described above, in order to input a punctuation mark during a use of the voice recognition service according to the related art, an automatic conversion method should be used.

When the method is not proper, the user terminates STT and inputs a desired symbol using an existing keyboard (or, keypad).

In a present voice input mode, since it cannot be known whether a user intends to input a punctuation mark or input a character, when a pre-registered keyword has been received as an input of a voice, the electronic device automatically switches the input voice into a punctuation mark.

This may create a problem; for example, the user may want to input a “period” character, but when the character has been previously registered as a keyword, the character may be automatically switched to a period.

As described above, a scheme of automatically making a punctuation mark cannot accurately reflect a user intention.

Accordingly, it needs to be clearly distinguished whether the user intends to input a punctuation mark or whether the user intends to input a language, and a method capable of accurately and easily inputting is necessary.

Further, the user may instruct not only the punctuation mark but also a command for editing in the voice input mode. Table 1 provides an example.

TABLE 1

1. input voice information
I named my pet pig cap bacon
2. output text information
I named my pet pig Bacon

As illustrated in the Table 1, when the user has input “cap” which is a pre-registered command keyword as a voice in the voice input mode, the first letter of a follow-up input word is entered as a capital letter so that “Bacon” is input.

There are commands like “cap” such as “new line”, “all caps”, and “no space”.

A case of the command input also has a problem identical to a case of a punctuation mark input. For example, even though the user intends to input character information, a command may be performed.

In order to prevent this, the user according to the related art terminates the STT and inputs a desired character by returning to a manual keyboard input mode.

In a case of composing e-mail, a command for editing a pre-written text may be also needed. The user may want to erase a part of the pre-written text or change the part of the text into bold or italic font.

Hereinafter, it can be expected that the editing command may be added in the voice text input mode.

An icon (emoticon), or the like is one element among elements which give a boost to a conversation between users. In a present voice input mode, an icon (emoticon) cannot be input.

The icon may be matched with a text having a meaning. For example, (̂_̂) may be substitute for “happy”. As the command, an icon input may be provided using the command and an icon input method of the case needs to be exactly separated from the character information input.

The present disclosure is provided address these issues. An aspect of the present disclosure is to provide a method and an apparatus of exactly recognizing a character information input, a punctuation mark input, a command input, and an emoticon (icon) input in a STT sentence input mode.

An embodiment of the present disclosure described below includes a method of providing a hand-writing area which can perform a character information input, a punctuation mark input, a command input, and an emoticon (icon) input during a STT input.

According to an embodiment of the present disclosure, a method of recognizing a trigger motion in order to perform the character information input, the punctuation mark input, the command input, and the emoticon (icon) input during the STT input will be provided.

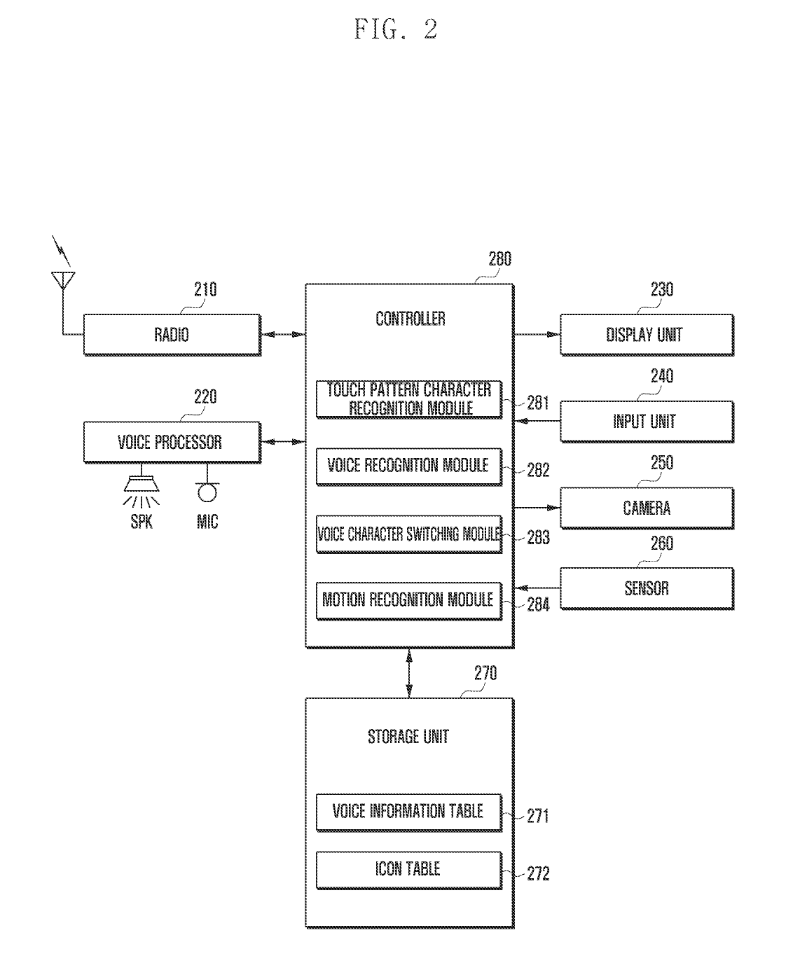

FIG. 2 is a block diagram illustrating an internal structure of an electronic device according to an embodiment of the present disclosure.

Referring to FIG. 2, the electronic device according to the present disclosure may include a radio 210, a voice processor 220, a display unit 230, an input unit 240, a camera 250, a sensor 260, a storage unit 270, and a controller 280.

The radio 210 transmits and receives data for a wireless communication of the electronic device. The radio 210 may include a Radio Frequency (RF) transmitter for up-converting and amplifying a frequency of a transmitted signal, an RF receiver for low noise amplifying a received signal and down-converting a frequency, and the like. Further, the radio 210 may receive data through a wireless channel to output the received data to the controller 280, and may transmit data output from the controller 280 through the wireless channel.

The voice processor 220 may process a user voice signal input through a microphone (MIC) into a form for transmission of the voice signal through the radio 210 and process a voice input through the radio 210 or various audio signals generated in the controller 280 as a signal in a form capable of outputting from a speaker (SPK).

The voice processor 220 according to the present disclosure may receive a voice signal from the outside and switch the voice signal into voice data which is a digital signal.

The display unit 230 may be formed of a Liquid Crystal Display (LCD), an Organic Light Emitting Diodes (OLED), an Active Matrix Organic Light Emitting Diodes (AMOLED), and the like, and may visually provide a menu of the electronic device, input data, function setting information, and other information to the user. The display unit 230 may perform a function of outputting a booting screen, an idle screen, a menu screen, a telephony screen, or other application screens of the electronic device.

The input unit 240 may receive an input of a user key operation for controlling an electronic device and generate an input signal to enable the input signal to be transmitted to the controller 280. The key input unit 240 may be configured as a key pad including a numeric key and a direction key, and be formed with a predetermined function key on one side of the electronic device.

The camera 250 receives light information input from the outside and then outputs the light information as an electronic signal and video signal. According to an embodiment of the present disclosure, the camera 250 may detect a user motion, or the like and transmit the user motion, or the like to the controller 280.

The sensor 260 may include at least one sensor among a gesture sensor, a gyro sensor, an atmospheric pressure sensor, a magnetic sensor, an acceleration sensor, a grip sensor, a proximity sensor, a Red, Green, Blue (RGB) sensor, a biometric sensor, a temperature/humidity sensor, an illumination sensor, or an ultra violet sensor.

The storage unit 270 may store an operation and a state of an electronic device or a program and data required when the controller 280 is controlled. Further, the storage unit 270 may use various volatile and/or non-volatile memory devices. Especially, the storage unit 270 according to the present disclosure stores a program for performing a character input function by voice recognition. In addition, the storage unit 270 may include a basic voice information table, an icon table, a punctuation mark table, and a command table.

The voice information table may store character information corresponding to each piece of voice information in a table type. Replacement character information may be configured as Korean characters, English capital letters, and English lower-case letters. The table may be included in a terminal as shown in the drawing or may be configured to be updated while being stored in a server (external) and used.

The icon table is a table in which an icon and a character are mapped. For example, when a user gives voice data which refers to “happy”, the voice data may be replaced with (̂_̂) character according to a mode.

The command table also stores information where a command and a corresponding operation are mapped. The command may be a text command or a pattern.

The punctuation mark table is a table where information such as a special character, a symbol, or the like is stored. The punctuation mark table may store information where a special character, a symbol, and a corresponding text command are mapped.

The controller 270 may control a signal flow every between blocks to operate the electronic device.

For example, the controller 270 may display an input mode screen including an input area and a display area in the input mode according to an embodiment of the present disclosure. The controller 270 determines whether at least one input between a touch input and a voice input through the input area is detected and may control the touch input and the voice input to be processed as a result of the determination. When a touch input has been detected, the controller 270 may control symbol information corresponding to the touch input to be displayed on the display area. When a voice input has been detected, the controller 270 may switch the voice information into character information and control the voice information to be displayed on the display area.

In the related art, an input can be performed through only a voice in an input mode using the STT. However, in the present disclosure, a separate input area is also provided in the input mode using the STT so that the symbol information can be easily input while the voice input is performed.

According to another embodiment of the present disclosure, the controller 270 may detect a motion in the input mode using the STT. When the motion has been detected in the input mode, the controller 270 may control to switch the input mode into an input mode corresponding to the detected motion. As described below, the input mode may include at least one mode among a sentence input mode, a punctuation mark input mode, a command input mode, and an icon input mode.

The controller 270 may include a voice recognition module 282, a voice character switching module 283, a touch pattern character recognition module 281 and a motion recognition module 284.

The voice recognition module 282 receives an input of voice data acquired from the voice processor 220 and detects a voice characteristic of the voice data so as to recognize the voice characteristic as voice information. The voice character switching module 283 switches voice information recognized by the voice recognition module 282 into character information. The voice character switching module 283 acquires the character information from the voice information.

The voice character switching module 283 refers to a basic voice information table of the storage unit 270 which stores a table where the voice information and the character information are mapped in order to switch the voice information into the character information. As shown in FIG. 2, the information may be included in the electronic device, or may be configured in a form to be updated by being stored in a server (external) and used.

The acquired character information may be used according to a present mode. For example, when a present configured mode is a sentence input mode, the character information text may be used as is. In addition, the present mode is the punctuation mark input mode, the input voice information may be switched into a corresponding punctuation mark in reference to a voice information table 271 of the storage unit 270. When the present mode is the command input mode, the input voice information is switched into a corresponding command in reference to the command table of the storage unit 270 and the corresponding command may be executed. In addition, when the present mode is the emoticon input mode, the input voice information may be switched into a corresponding emoticon based on an icon table 272 of the storage unit 270. As described above, a method of switching a mode will be described in a motion recognition module to be described below.

In the motion recognition module 284, a user motion (or action) input through the camera 250 or the sensor 260.

In an embodiment of the present disclosure, the recognized motion may be used as a triggering point. The sensor 260 may use a proximity sensor for recognizing an approach of an object and use an infrared sensor which can recognize an operation. Based on mapping information on a specific motion and an input mode, character information output in a STT mode may be properly utilized.

When a triggering is performed through the motion, the STT mode may be switched into the punctuation mark input mode and input a punctuation mark through a voice. With another triggering operation, the STT mode may be switched into the command input mode. Further, with another triggering operation, the STT mode may be switched into the icon input mode.

The three operations recognized as the triggering point may be identical motions or different types of motions. For a user guide of the motions, a motion and/or a direction may be displayed through a user interface (UI) in the display unit 230. The operations will be described in detailed in reference to the drawings in a following corresponding part.

According to an embodiment of the present disclosure, a punctuation mark, a command, an emoticon, or the like may be input without switching a mode through motion recognition in the input mode. For example, when a specific pattern has been input in the touch pattern character recognition module 281, an emoticon, a punctuation mark, or a command may be simultaneously input also in the sentence input mode.

According to an embodiment of the present disclosure, an electronic device may switch an input pattern into character information and switch corresponding character information into a corresponding character based on the icon table, the punctuation mark table, and the command table of the storage unit or execute a command.

When the three types of tables have a common denominator, according to a priority which a user or a terminal determines, it may be configured to use data searched in a table which has a high priority.

Even though the controller 270 includes separate detail blocks and a function which a controller and the detail blocks perform has been separately described as mentioned above, a function which the voice recognition module 282 performs may be directly performed (executed) by the controller 270, in the manner of hardware or software.

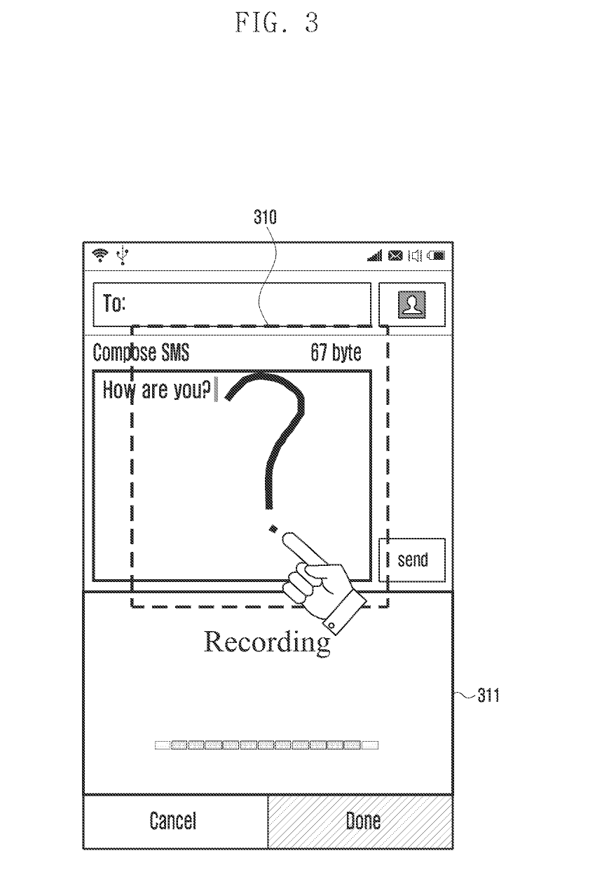

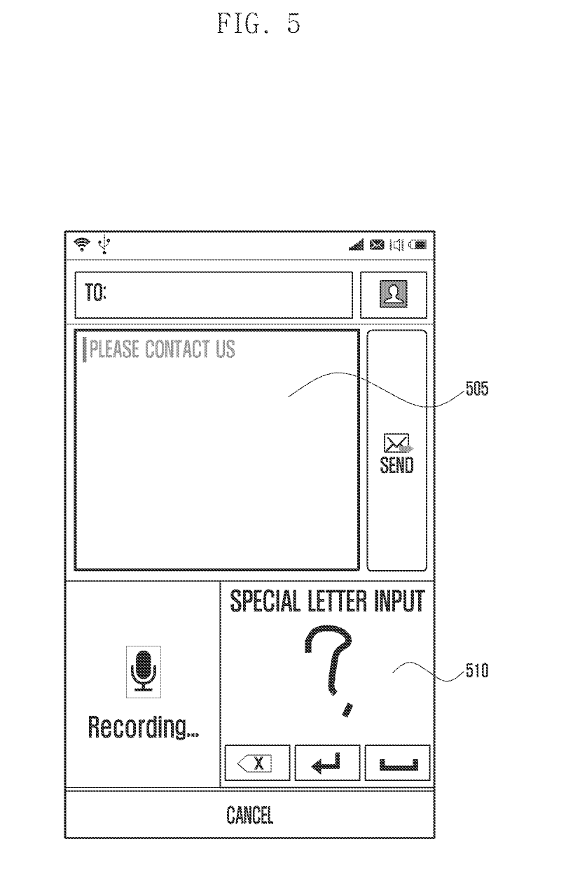

FIGS. 3, 4, and 5 illustrate an input processing method in a STT input mode according to an embodiment of the present disclosure.

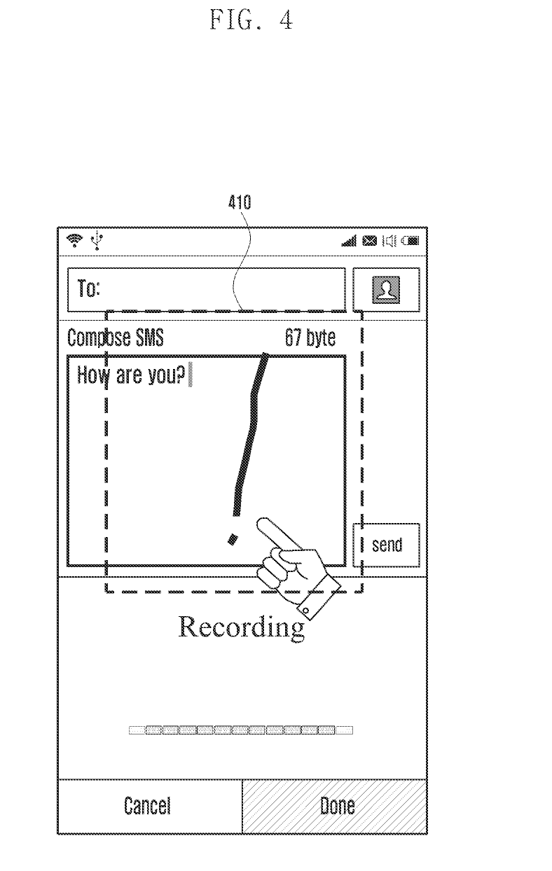

Referring to FIGS. 3 to 5, a method of processing a voice input and a touch input through an input area in an input mode using STT is illustrated. For example, FIGS. 3 and 4 illustrate a solution scheme for inputting a punctuation mark in the input mode using the STT.

In a general case in which a user holds an electronic device with a hand, a punctuation mark input through input areas 310, 410, and 510 based on handwriting may be one method among the easiest methods.

To this end, an electronic device according to an embodiment of the present disclosure may switch all voice information inputs as voice into character information and switch a touch input, input through the input area, into symbol information of a special letter, a symbol, or the like.

In an embodiment of the present disclosure, the display unit or the specific areas 310, 410, and 510 on a screen is assumed as a size of a cursor and a punctuation mark may be input by drawing with a hand. A touch input, input through the specific areas 310, 410, and 510, may be switched into the symbol information so that the symbol information can be easily input even in an input mode using the STT.

In addition, an input such as an enter or a space may be input by mapping a specific pattern or may be selected using a separate soft button.

The input area configuration for a hand-writing input may use arbitrary areas (e.g., empty areas) 310 and 410 of the display unit of the electronic device, as shown in FIGS. 3 and 4.

For example, the arbitrary area may be a part where text does not exist (a text is not displayed) among the display area. Further, according to various embodiments of the present disclosure, the user may process a touch recognized in the part where the text is not displayed among the display areas where the text, which the user is inputting, is displayed. In this event, a touch of a text part may be processed as a cursor movement command.

For example, the empty area may use a specific part 311 of the display unit which is separated from the text display area.

According to another embodiment of the present disclosure, a display area 505 displaying an input character or symbol and an input area 510 for hand writing may be separately configured.

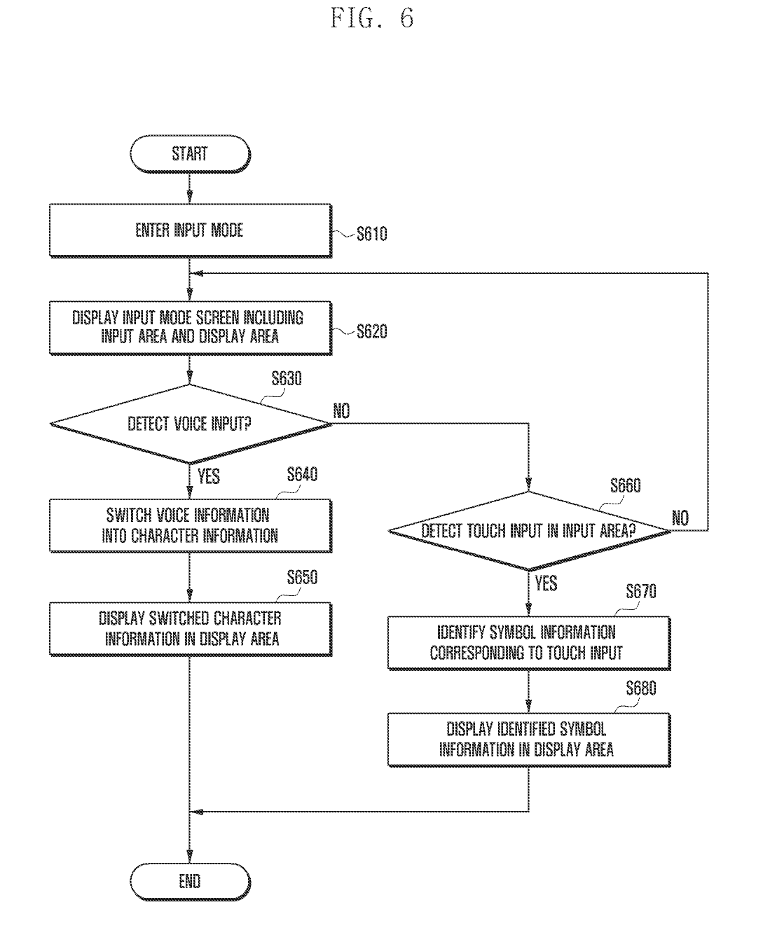

FIG. 6 is a flowchart illustrating an operation order of an electronic device according to an embodiment of the present disclosure.

An electronic device may detect that the electronic device has entered an input mode in operation S610. The input mode may be a function provided in an application embedded in the electronic device or may be a function provided in an application which a user directly downloads from an application server, or the like. For example, the user may desire to input a specific character, a symbol, or the like in an input mode of a short message service (SMS), a multimedia message service (MMS), or the like.

The electronic device may display an input mode screen including an input area and a display area in operation S620. The input area may be an area for detecting a user hand writing input. According to an embodiment of the present disclosure, the input area may be implemented based on a touch screen which can detect a touch. The display area may be an area which switches a user voice input into character information and displays the voice input or an area which switches an input detected through the input area into symbol information and then displays the input.

The electronic device determines whether a voice input is detected in operation S630.

When the voice input has been detected, the electronic device may switch a detected voice input into the character information based on the STT in operation 5640. The electronic device may display the switched character information on the display area in operation 5650.

On the other hand, when the voice input has not been detected, the electronic device may determine whether a touch input is detected in the input area in operation 5660. When the touch input has been detected in the input area, the electronic device may identify symbol information corresponding to the touch input in operation 5670. For example, the electronic device may identify a switched table, e.g., a punctuation mark table, a command table, an emoticon table, or the like stored in the storage unit 270 and determine whether the symbol information corresponding to the touch input exists.

The electronic device may display the identified symbol information on the display area in operation 5680.

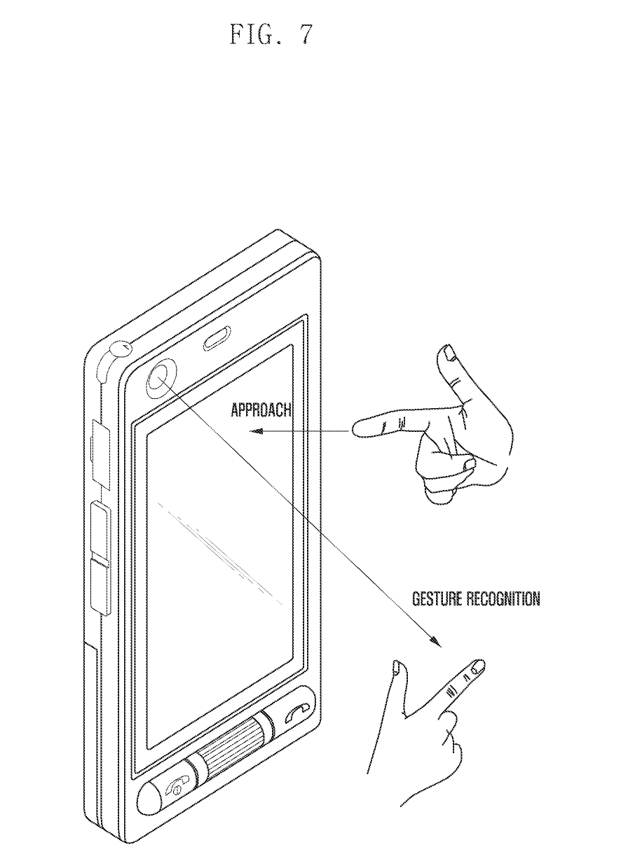

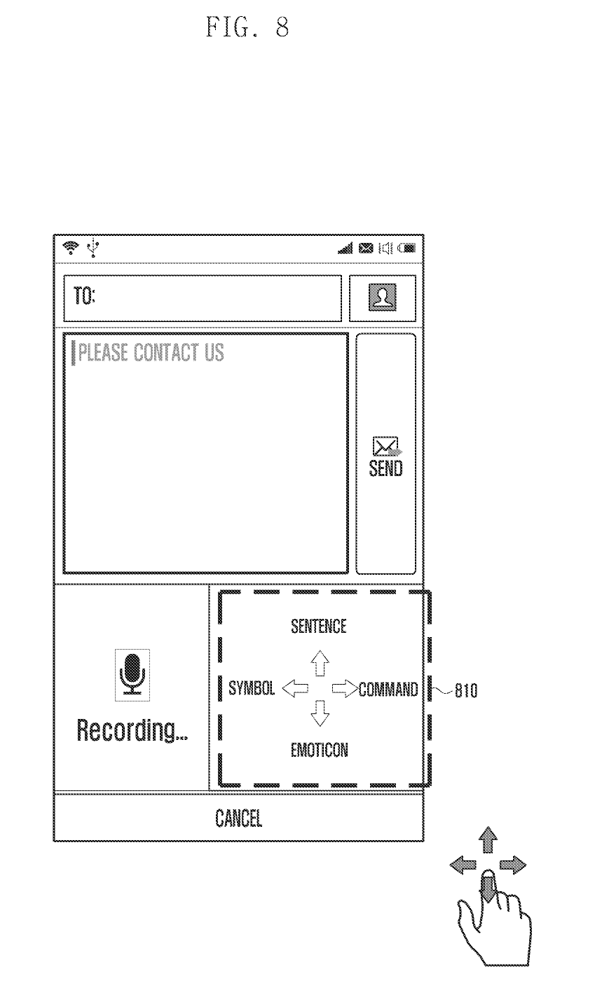

FIGS. 7 and 8 illustrate an input mode switching method according to an embodiment of the present disclosure. FIGS. 7 and 8 illustrate a method of switching an input mode through a motion input.

Referring to FIGS. 7 and 8, when a user cannot perform an exact touch input, for example, when a user is driving a car, an input using hand writing cannot be performed like the embodiment as described above. In this event, a method of switching a mode through a specific input (e.g., user action, motion) to enable a result value range to be input more exactly may be needed.

Four types of the input modes exemplified (provided) in the embodiment of the present disclosure are a character input mode, a punctuation mark input mode, a command input mode, and an emoticon input mode. Of course, another input mode other than the four types of input modes as described above may be additionally configured.

The character input mode is a mode which inputs a general STT string.

When the user wants to input symbol information (a specific character and/or symbol) through voice recognition, the input mode may be switched through a motion (gesture) as shown in FIG. 7 so that only a corresponding type of character can be input.

It is possible to make a completed STT message, in which a punctuation mark exists, to be written with only the voice input.

The motion, i.e., an example of a specific user action is as follows. The input mode may be changed or switched through a front camera and an infrared (IR) sensor or a proximity sensor.

For example, as shown in FIG. 8, within a predetermined proximity distance of a front part of the electronic device, a motion such as from top to bottom, from bottom to top, from left to right, from right to left, or the like may be performed. Information on the motion may be displayed through a mode switching area 810 in a part area of the display unit of the electronic device and provide a guideline to the user.

When a present mode of the electronic device is a sentence input mode, character information text generated in the voice character switching module may be used as it is. The voice information which the user inputs may be switched into text information by STT and the switched text information may be displayed on the display unit as it is.

When the present input mode is the punctuation mark input mode, the electronic device may switch voice information input by the user into a corresponding punctuation mark in reference to the punctuation mark table of the storage unit 270.

When the present input mode is the command input mode, the electronic device may switch voice information input by the user into a corresponding command in reference to the command mark table of the storage unit 270. Further, the electronic device may perform the switched command. For example, the voice information input by the user may be switched by a command so that a line can be changed or a lower-case letter can be switched into a capital letter.

When the present input mode is the emoticon input mode, the electronic device may switch voice information input by the user into a corresponding icon in reference to the icon table of the storage unit 270.

As described above, according to an embodiment of the present disclosure, in each input mode, only a character or symbol information supported in each mode may be input.

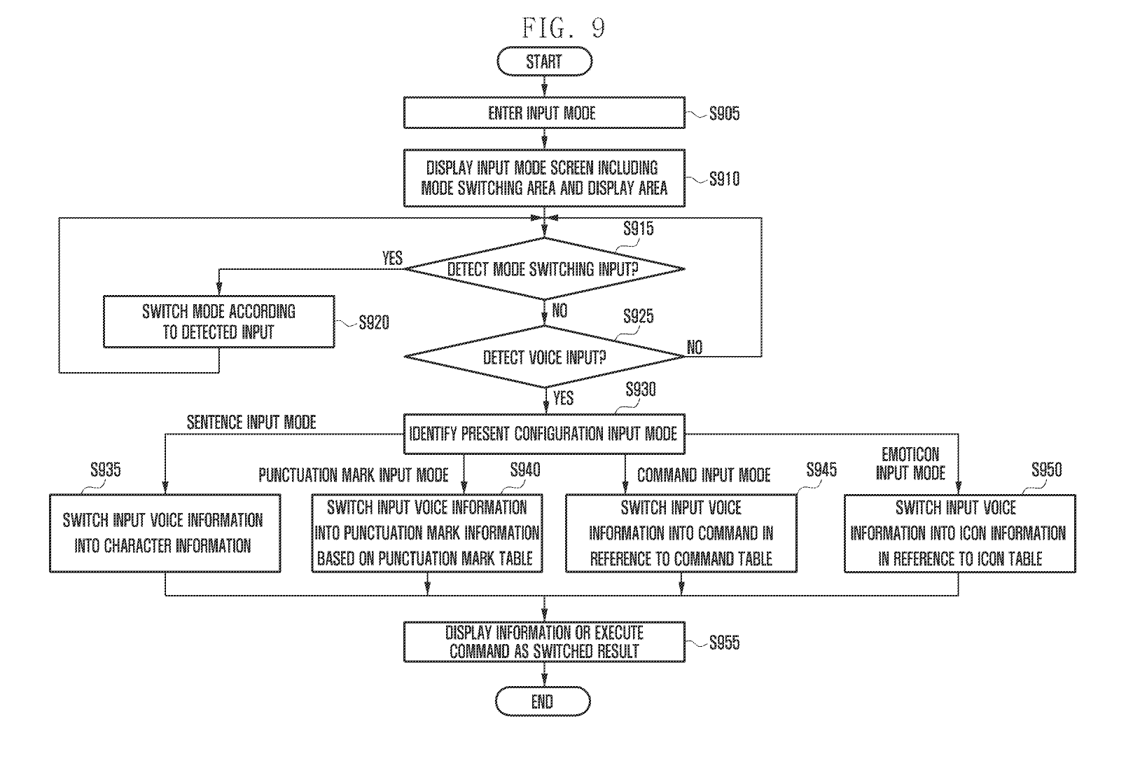

FIG. 9 is a flowchart illustrating an input mode switching process according to an embodiment of the present disclosure.

Referring to FIG. 9, an electronic device may detect entering an input mode in operation S905. The input mode may be a function provided in an application embedded in the electronic device or may be a function provided in an application which a user directly downloads from an application server, or the like. For example, the user may desire to input a specific character, a symbol, or the like in an input mode of a short message service (SMS), a multimedia message service (MMS), or the like.

The electronic device may display an input mode screen including a mode switching area and a display area in operation S910. The mode switching area may display information on a motion which can switch an input mode. As described above, in the switching area, a mapping relation between a motion such as from top to bottom, from bottom to top, from left to right, from right to left, or the like and an input mode respectively corresponding to the motion may be displayed.

In addition, the electronic device may determine whether an input for switching the input mode has been detected in operation S915. For example, the electronic device may determine whether a motion previously configured through a camera, a motion sensor, or the like has been detected.

When the mode switching input has been detected, the electronic device may switch the input mode according to the detected mode switching input in operation S920. For example, when a motion from left to right has been detected, the electronic device may switch a present input mode into the command input mode.

When the mode switching input has not been detected, the electronic device may determine whether a voice input has been detected in operation S925.

When the voice input has been detected, the electronic device may identify a presently configured input mode in operation S930.

When the presently configured input mode is the sentence input mode, the electronic device may switch input voice information into character information based on the STT in operation S935.

When the presently configured input mode is the punctuation mark input mode, the electronic device may switch input voice information into punctuation mark information based on the punctuation mark table in operation S940.

When the presently configured input mode is the command input mode, the electronic device may switch input voice information into a command based on the command table in operation S945.

When the presently configured input mode is the emoticon input mode, the electronic device may switch input voice information into an emoticon based on the icon table in operation S950.

The electronic device may display the switched information as a result of the switching or perform a command in operation S955.

According to the present disclosure, all pieces of voice information and input information are recognized in the input mode so that the recognized voice information and input information can be switched into a character or a symbol and then be output. Further, according to the present disclosure, the input mode can be easily switched additionally using an input such as a motion other than the voice input.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a display unit configured to display character information and symbol information;
an input unit configured to receive a user input;
a microphone configured to receive a voice input; and
a controller configured to control to display an input mode screen including an input area and a display area, to determine whether at least one input between a touch input and a voice input through the input area is detected, and to process the touch input and the voice input as a result of the determination so as to display the touch input and the voice input.

2. The electronic device of claim 1, wherein the controller displays character or symbol information corresponding to the touch input on the display area when the touch input has been detected.

3. The electronic device of claim 1, wherein the touch input is determined according to whether the touch input is detected through an arbitrarily configured input area and the input area comprises a whole or a part of the display area or an arbitrary area other than the display area in a screen.

4. The electronic device of claim 1, wherein, when the voice input has been detected, the controller switches the voice information into the character information and displays the switched voice information on the display area, determines whether symbol information corresponding to the character information exists based on a pre-configured switching table, and displays corresponding symbol information when the corresponding symbol information exists.

5. The electronic device of claim 4, wherein the input area is configured as a space other than a text which is being input in the display area.

6. An electronic device comprising:
a display unit configured to display character information or symbol information;
an input unit configured to receive an input of a user input;
a microphone configured to receive a voice input;
a sensor configured to detect a motion; and
a controller configured to control to determine whether a motion input for an input mode switching is detected and, when the motion input has been detected, to switch an input mode into at least one input mode among a sentence input mode, a punctuation mark input mode, a command input mode, and an icon input mode, to determine whether a user input or a voice input is detected, and, when the user input or the voice input has been detected, to switch the detected input according to the identified input mode so as to display the switched input mode.

7. The electronic device of claim 6, wherein the controller switches the voice input into the character information so as to display the switched voice input when the identified input mode is the sentence input mode.

8. The electronic device of claim 6, wherein, when the identified input mode is the punctuation mark input mode, the controller identifies a punctuation mark corresponding to the voice input based on a punctuation mark table and switches the voice input into the identified punctuation mark so as to display the switched voice input.

9. The electronic device of claim 6, wherein, when the identified input mode is the command input mode, the controller identifies a command corresponding to the voice input based on a command table and switches the voice input into the identified command so as to execute the switched voice input.

10. The electronic device of claim 6, further wherein, when the identified input mode is the command input mode, the controller identifies a command corresponding to the voice input based on a command table and switches the voice input into the identified command so as to execute the switched voice input.

11. A method of processing an input in an electronic device, the method comprising:
displaying an input mode screen including an input area and a display area;
determining whether at least one input between a touch input and a voice input through the input area is detected; and
processing the touch input and the voice input as a result of the determination so as to display the touch input and the voice input.

12. The method of claim 11, wherein the processing of the touch input and the voice input so as to display the touch input and the voice input comprises displaying character or symbol information corresponding to the touch input on the display area when the touch input has been detected.

13. The method of claim 11, wherein the processing of the touch input and the voice input so as to display the touch input and the voice input comprises controlling to switch the voice information into the character information so as to display the switched voice information on the display area when the voice input has been detected or determine whether the symbol information corresponding the character information exists based on a pre-configured switching table and when the symbol information exists, display the corresponding symbol information.

14. The method of claim 11, wherein the touch input is determined according to whether the touch input is detected through an arbitrarily configured input area and the input area comprises a whole or a part of the display area or an arbitrary area other than the display area in a screen.

15. The method of claim 14, wherein the input area is configured as a space other than a text which is being input in the display area.

16. A method of switching an input mode in an electronic device, the method comprising:
entering an input mode;
determining whether a motion input for an input mode switching is detected; and
when the motion input has been detected, switching the input mode into at least one input mode among a sentence input mode, a punctuation mark input mode, a command input mode, and an icon input mode, and determining whether a user input or a voice input is detected, and, when the user input or the voice input has been detected, switching the input mode into the detected input according to the present identified input mode so as to display the switched input mode.

17. The method of claim 16, wherein the displaying of the switched input mode comprises switching the voice input into character information so as to display the switched voice input when the identified input mode is a sentence input mode.

18. The method of claim 16, wherein the displaying of the switched input mode further comprises:
identifying a punctuation mark corresponding to the voice input based on a punctuation mark table when the identified input mode is the punctuation mark input mode; and
switching the voice input into the identified punctuation mark so as to display the switched voice input.

19. The method of claim 16, wherein the displaying of the switched input mode further comprises:
identifying a command corresponding to the voice input based on a command table when the identified input mode is the command input mode; and
switching the voice input into the identified command so as to execute the switched voice input.

20. The method of claim 16, wherein the displaying of the switched input mode further comprises:
identifying an icon corresponding to the voice input based on an icon table when the identified input mode is an icon input mode; and
switching the voice input into the identified icon so as to display the switched voice input.
